(19) United States
(12) Patent Application Publication
(10) Pub. No.: US 2014/0253825 A1
(43) Pub. Date: Sep. 11, 2014

(54) TOUCH PANEL AND MANUFACTURING METHOD THEREOF

(71) Applicant: NANCHANG O-FILM TECH. CO., LTD., Jiangxi (CN)

(72) Inventor: Zhao He, Jiangxi 330013 (CN)

(73) Assignee: NANCHANG O-FILM TECH. CO., LTD., JIANGXI 330013 (CN)

(21) Appl. No.: 13/985,950

(22) PCT Filed: Jul. 8, 2013
(86) PCT No.: PCT/CN2013/079000

§ 371 Date: Aug. 16, 2013

(30) Foreign Application Priority Data
Mar. 8, 2013 (CN) 201310074917.1

(51) Int. Cl. G02F 1/1333

(52) U.S. Cl. CPC G02F 1/13338
USPC 349/12; 427/108

(57) ABSTRACT

A touch panel is disclosed including a rigid transparent insulating substrate; a sensing electrode layer formed on a surface of the rigid transparent insulating substrate, the sensing electrode layer includes a plurality independently disposed sensing electrodes; a transparent insulating layer formed on the sensing electrode layer; and a driving electrode layer formed on the transparent insulating layer, the driving electrode layer includes a plurality of independently disposed driving electrodes; each of the driving electrodes comprises a meshed conductive circuit; the meshed conductive circuit is embedded or buried in the transparent insulating layer. A manufacturing method of the touch panel is also provided. The touch panel has a low cost and a high sensitivity.

### FIELD OF THE DISCLOSURE

The present disclosure relates to a field of touch technology, and more particularly relates to a touch panel and a manufacturing method thereof.

### BACKGROUND OF THE DISCLOSURE

Touch panel is widely used in various kinds of electronic devices with screens, such as computers or electronic devices which include smart phone, TV, PDA, tablet PCs, notebook computers, machine tools with industrial display touch, integrated computers and ultra-books, etc. The touch panel can be divided into a capacitive touch panel, a resistive touch panel and a surface wave touch panel etc. according to a working principle.

The capacitive touch panel functions by utilizing the induced current of a human body. When a finger touches the touch panel, the user and a surface of the capacitive touch panel form a coupling capacitor due to a body electric field, for a high frequency current, the capacitor is a conductor, a small current pass through from the contact point of the finger. The current flow out from electrodes located in four corners of the capacitive touch panel, and the currents pass through the four electrodes are proportional to distances between the finger and four corners, the four current ratios are precisely calculated by a controller to get a position of the touch point.

All current touch panels are using ITO (indium tin oxide) glass or ITO film (i.e. formed on the glass or on the film) to form patterns of driving electrodes and sensing electrodes. But the driving electrode and sensing electrode patterns formed by the ITO glass or ITO film have the following disadvantages: on one hand, the ITO driving electrode or sensing electrode bulges on the surface of the glass or transparent film, it is easy to be scratched or peeled off, which would lead to the decrease of the production yield; on the other hand, the main material of ITO glass or ITO film is a rare metal of indium, the indium is rare, so the cost is high, and a resistance or a surface resistance of a large size touch ITO panel is large, which affects the signal transmission speed and results in poor touch sensitivity, thus affecting the electronic product functions, and the user experiences are poor.

The conventional touch panel is too thick, which affects the whole thickness of the phone or such devices.

### SUMMARY OF THE DISCLOSURE

The present disclosure is directed to provide a touch panel with low cost and high sensitivity.

According to an aspect of the present disclosure, a manufacturing method of the touch panel is provided.

A touch panel includes: a rigid transparent insulating substrate; a sensing electrode layer formed on a surface of the rigid transparent insulating substrate, the sensing electrode layer includes a plurality independently disposed sensing electrodes; a transparent insulating layer formed on the sensing electrode layer; and a driving electrode layer formed on the transparent insulating layer, the driving electrode layer includes a plurality of independently disposed driving electrodes; each of the driving electrodes includes a meshed conductive circuit; the meshed conductive circuit is embedded or buried in the transparent insulating layer.

A method of manufacturing a touch panel includes the following steps: providing a rigid transparent substrate; forming a sensing electrode layer on a surface of the rigid transparent substrate; forming a transparent insulating layer on the sensing electrode layer; and forming a driving electrode layer on the transparent insulating layer; a driving electrode of the driving electrode layer is a meshed conductive circuit which includes a large amount of cells of the mesh.

The driving electrode of the touch panel is manufactured to the conductive mesh formed by the meshed conductive circuit in the above method, the touch panel do not have the problems that the surface is easy to be scratched or peeled off, the cost is high, the surface resistance is high for the large size panel when the thin ITO film is used, so the cost of the touch panel is low, the sensitivity is high. Furthermore, compared to the conventional touch panel, the second transparent substrate is omitted in the touch panel of the present disclosure; the thickness of the touch panel is reduced.

### BRIEF DESCRIPTION OF THE DRAWINGS

FIG. 1 is a schematic view of an electronic device having a touch panel of the present disclosure.

FIG. 2 is a cross sectional view of the touch panel in accordance with a first embodiment.

FIG. 3 is a cross sectional view of an embodiment in FIG. 2.

FIG. 4 is a schematic plan view of a driving electrode layer of FIG. 3 forming on a transparent insulating layer.

FIG. 5 is a sectional view taken along the line a-a′ in FIG. 4.

FIG. 6 is a sectional view taken along the line b-b′ in FIG. 4.

FIG. 7 is a schematic plan view of a sensing electrode layer of FIG. 3 forming on a surface of a rigid transparent insulating substrate.

FIG. 8 is a sectional view taken along the line A-A′ in FIG. 7.

FIG. 9 is a sectional view taken along the line B-B′ in FIG. 7.

FIG. 10a and FIG. 10b are schematic views of arrangements and shapes of the sensing electrodes and driving electrodes.

FIG. 11a, FIG. 11b, FIG. 11c and FIG. 11d are partially enlarged views correspond to part A of FIG. 10a or part B of FIG. 10b respectively in accordance with one embodiment.

FIG. 12 is a flowchart of a method of manufacturing a touch panel in accordance with one embodiment.

FIG. 13 is a specific flowchart of step 104 of a process shown in FIG. 12.

FIG. 14 is a layered structure of the driving electrode layer obtained according to step 104 of a process shown in FIG. 13.

### DETAILED DESCRIPTION OF THE EMBODIMENTS

Illustrative embodiments of the disclosure are described below. The following explanation provides specific details for a thorough understanding of and enabling description for these embodiments. One skilled in the art will understand that the disclosure may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Fillitionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

The “transparent” described in the transparent insulating substrate of the present disclosure can be explained as “transparent” or “substantially transparent”; the “insulating” in the transparent insulating substrate can be explained as “insulating” or “dielectric”. So the “transparent insulating substrate” of the present invention can be explained as but not limited to transparent insulating substrate, substantially transparent insulating substrate, transparent dielectric substrate and substantially transparent dielectric substrate.

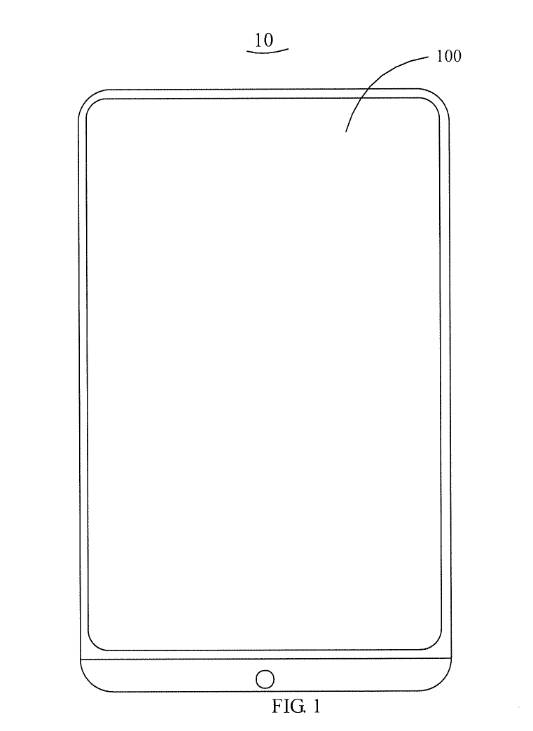

FIG. 1 shows one embodiment of an electronic device having a touch panel of the present disclosure, the electronic device 10 is a smart phone or a tablet PC. In the electronic device 10, the touch panel 100 is bonded to an upper surface of a display screen, which is used in one of I/O devices of an electronic device for human computer interaction. It is to be understood that, the touch panel 100 of the present disclosure can also be applied to electronic devices such as a mobile phone, a mobile communication phone, a TV, a tablet PC, a notebook computer, a machine tool with a touch display screen, a GPS equipment, an integrated computer and an ultrabook.

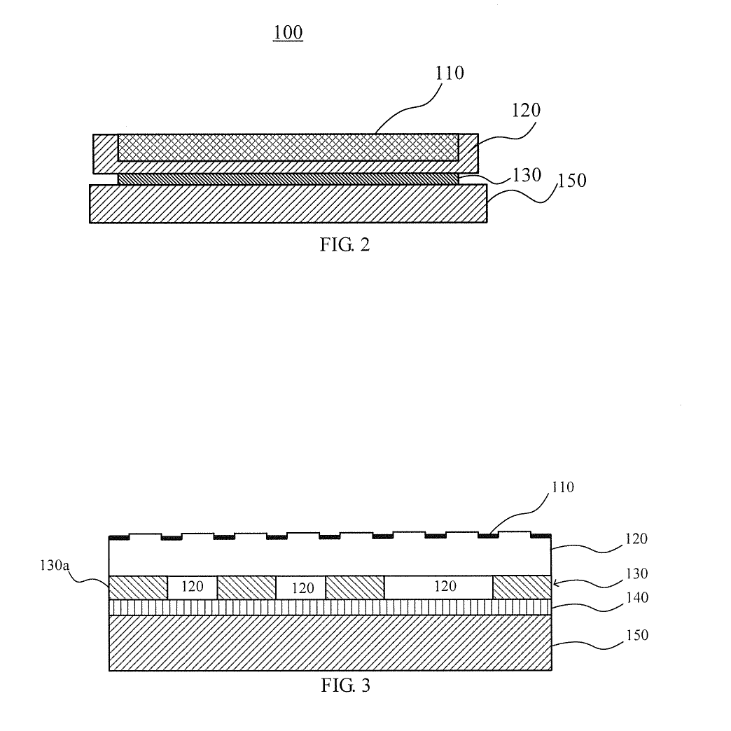

Referring to FIG. 2, it is a cross-sectional view of the touch panel 100 of the present disclosure in accordance with one embodiment. The touch panel 100 includes a driving electrode layer 110, a transparent insulating layer 120, a sensing electrode layer 130 and a rigid transparent insulating substrate 150. The sensing electrode layer 130 is formed on a surface of the rigid transparent insulating substrate 150. The driving electrode layer 110 is formed on the transparent insulating layer 120, each driving electrode of the driving electrode layer 110 includes a meshed conductive circuit, and the meshed conductive circuit is embedded or buried in the transparent insulating layer 120.

The touch panel 100 includes at least one tackifier layer 140, which is used to increase the adhesive strength between the sensing electrode layer 130 and the transparent insulating substrate. The tackifier layer 140 is usually made of optically transparent OCA (optical clear adhesive) or LOCA (liquid optical clear adhesive).

The transparent insulating layer 120 is made of a material selected from a group consisting of OCA, UV (ultraviolet) adhesive, thermosetting adhesive or air-drying adhesive, etc. The OCA and UV adhesive are both transparent adhesives, which can ensure the transmittance of the touch panel 100. It is to be understood that the transparent insulating layer 120 is called imprinting-adhesives in the industry.

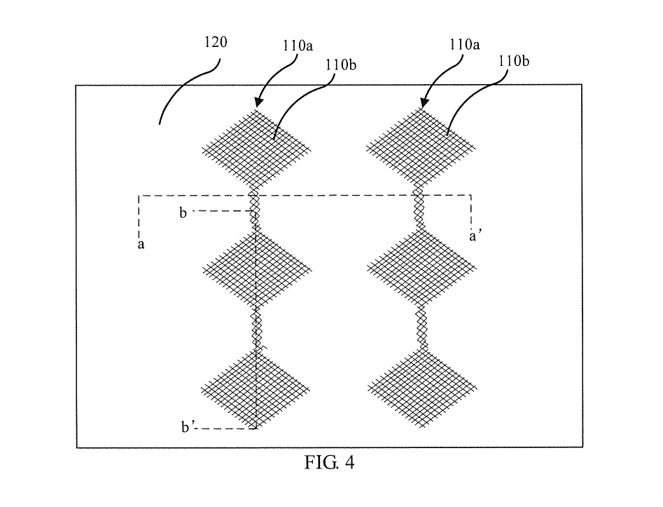

Referring to FIG. 3, it is a schematic cross-sectional view of the touch panel according to a specific embodiment of the present disclosure. The sensing electrode layer 130 includes a plurality of independently disposed sensing electrodes 130a. Referring to FIG. 4, the driving electrode layer 110 includes a plurality of independently disposed driving electrodes 130a, each driving electrode includes a meshed conductive circuit 110b. “Independently disposed” described in the disclosure can be understood but not limit to several explanations of “independently disposed”, “spaced disposed” or “insulated disposed”.

In the capacitive touch panel, the sensing electrode and driving electrode are essential two parts of the touch sensing components. The sensing electrode is usually close to a touch surface of the touch panel, the driving electrode is away from the touch surface. The driving electrode is connected to a scaning signal generating device, the scaning signal device provides a scaning signal, and the sensing electrode generates changed parameters when it is touched by a charged conductor to sense the touch position of the sensing region.

Each sensing electrode of the sensing electrode layer 130 is electrically connected to a peripheral sensing detection processing module of the touch panel, each driving electrode of the driving electrode layer 110 is electrically connected to a peripheral excitation signal module of the touch panel, and the sensing electrode and the driving electrode form a mutual capacitor therebetween. When a touch operation occurs on the surface of the touch panel, the mutual conductance of the touch center region will change, the touch operation is converted into an electrical signal, a coordinate data of the touch center region can be obtained by processing the data of the capacitance variation region, the electronic device which can process the related data gets the corresponding exact position of the touch operation on a screen attached to the touch panel according to the coordinate of the touch center region, thus the corresponding function and input operation can be completed.

In the illustrated embodiment, the sensing electrode layer 130 and the driving electrode layer 110 of the present disclosure are manufactured by different ways, different materials and different manufacturing processes.

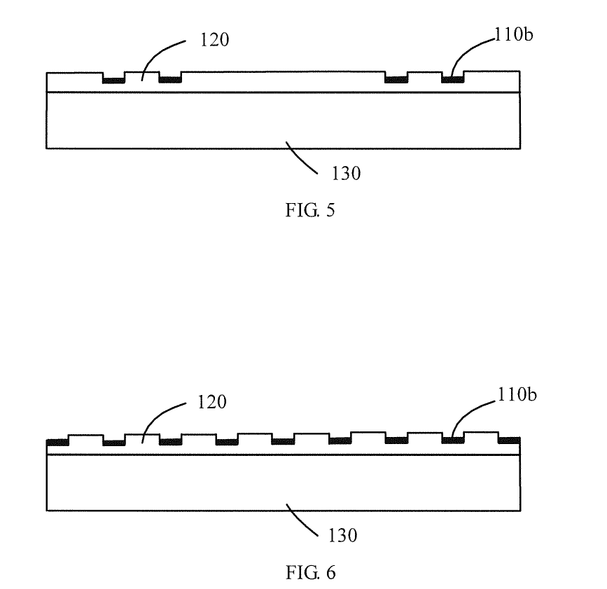

Specifically, both FIG. 5 and FIG. 6 are cross-sectional views taken along the lines of a-a′ and b-b′ respectively. The driving electrode layer 110 includes a plurality of independently disposed meshed conductive circuits 110b. The meshed conductive circuit 110b is embedded or buried in the transparent insulating layer 120. The meshed conductive circuit 110b is made of a material selected from a group consisting of gold, silver, copper, aluminum, zinc, gold-plated silver and alloys of at least the above two metals. The above materials are easy to obtain and have low cost, especially the meshed conductive circuit made of conductive silver paste has good conductivity and low cost.

It is easy to be understood that, there are several ways that the meshed conductive circuit are embedded or buried in the transparent insulating layer 120. In one preferred embodiment, the transparent insulating layer 120 defines a plurality of interlaced meshed trenches, the meshed conductive circuit 110b is disposed in the trenches, thus the meshed conductive circuit 110b is embedded or buried in the surface of the transparent insulating layer 120. In the process of moving or handling, the driving electrode 110a can be firmly attached to the rigid transparent insulating substrate 150, it is not easy to be damaged or peeled off.

Specifically, a mesh spacing of the meshed conductive circuit 110b is defined as d1, and 100 μm≦d1<600 μm; a surface resistance of the meshed conductive circuit is defined as R, and 0.1 Ω/sq≦R<200 Ω/sq.

The surface resistance R of the meshed conductive circuit 110b affects the transmission speed of the current signal, thus affecting the responsiveness of the touch panel. Therefore, the surface resistance R of the meshed conductive circuit 110b is preferably defined as R, and 1 Ω/sq≦R≦60 Ω/sq. The surface resistance R in this range can significantly increase the conductivity of the conductive film and significantly improve the signal transmission speed, and the accuracy requirement is lower compared to that of the surface resistance of 0.1 Ω/sq≦R≦200 Ω/sq, the technical requirement is reduced on the premise of ensuring conductivity, the cost is reduced. It is to be understood in the manufacturing process, the surface resistance of the meshed conductive circuit 110b (R) is codetermined by several factors of the mesh spacing, material, traces diameter (traces width).

A mesh traces width of the meshed conductive circuit 110b is defined as d2, and 1 μm≦d2≦10 μm. The traces width of the mesh affects the transmittance of the conductive film, the smaller the traces width, the better the transmittance is. When the mesh traces spacing d1 of the meshed conductive circuit is defined as 100 μm≦d1<600 μm, the surface resistance R of the meshed conductive circuit 110b is defined as 0.1 Ω/sq≦R<200 Ω/sq, the mesh traces width d2 is defined as 1 μm≦d2≦10 μm which can satisfy the requirement, and can at the same time enhance the transmittance of the touch panel. Especially when the mesh traces width d2 of the meshed conductive circuit 110b is defined as 2 μm≦d2<5 μm, the larger the transmittance area, the better the transmittance is, and the accuracy requirement is relatively low.

In a preferred embodiment, the meshed conductive circuit is made of silver, and it uses a regular pattern, the mesh traces spacing ranges from 200 μm to 500 μm; a surface resistance of the meshed conductive circuit is defined as R, and 4 Ω/sq≦R<50 Ω/sq, the coating amount of silver ranges from 0.7 g/m2 to 1.1 g/m2.

In a first embodiment, d1=200 μm, R=4 to 5 Ω/sq, the silver amount is 1.1 g/m2, the grid traces width d2 ranges from 500 nm to 5 μm. It is to be understood, a value of the surface resistance R, an amount of silver would be affected by the grid traces width d2 and filling trench depth, the larger the grid traces width d2, the larger the filling trench depth is, the surface resistance would increase, the silver amount would also increase.

In a second embodiment, d1=300 μm, R=10 Ω/sq, the silver amount ranges from 0.9 to 1.1 g/m2, the mesh traces width d2 ranges from 500 nm to 5 μm. It is to be understood, a value of the surface resistance R, an amount of the silver would be affected by the grid traces width d2 and filling trench depth, the larger the grid traces width d2, the larger the filling trench depth is, the surface resistance would increase, the silver amount would also increase.

In a third embodiment, d1=500 μm, R=30 to 40 Ω/sq, the silver amount is 0.7 g/m2, the mesh traces width d2 ranges from 500 nm to 5 μm. It is to be understood, a value of the surface resistance R, an amount of the silver would be affected by the mesh traces width d2 and filling trench depth, the larger the grid traces width d2, the larger the filling trench depth is, the surface resistance would increase; the silver amount would also increase.

It is to be understood, besides that the meshed conductive circuit 110b is made of metal conductive material; it can also be made of a material selected from a group consisting of transparent conductive polymers, carbon nanotubes and graphene.

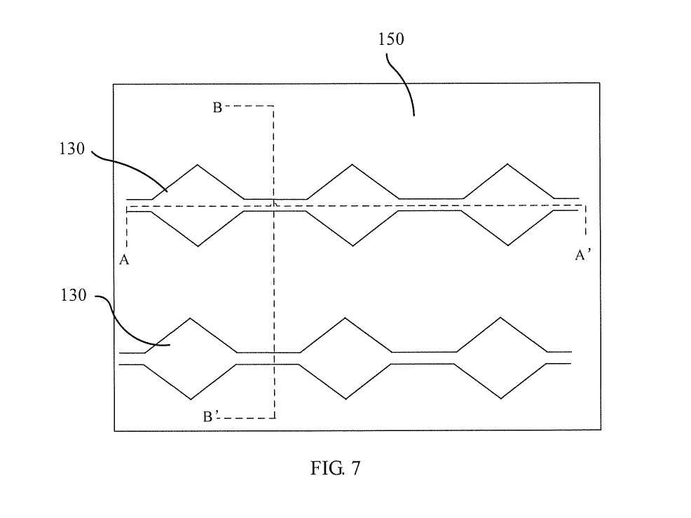

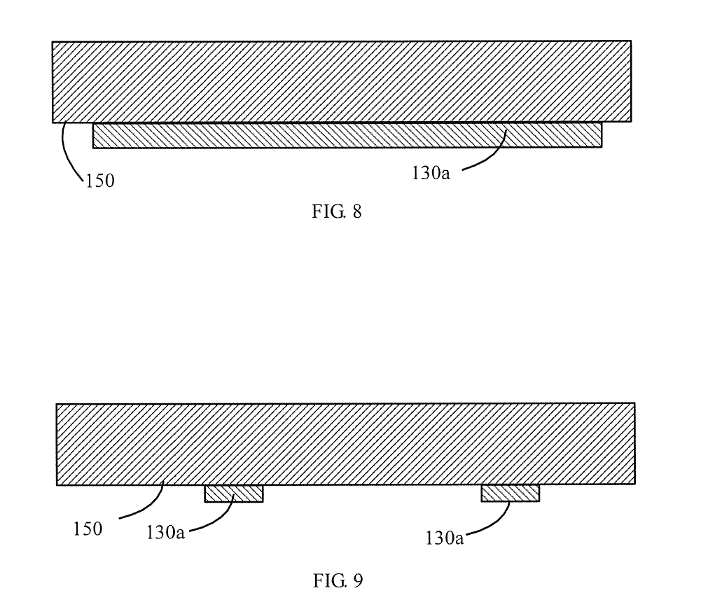

Referring to FIG. 7, FIG. 8 and FIG. 9, the sensing electrode of the sensing electrode layer 130 is made of a material selected from a group consisting of the ITO (Indium Tin Oxide), ATO (Antimony Doped Tin Oxide), IZO (Indium Zinc Oxide), AZO (Aluminum Zinc Oxide), PEDOT (Polyethylene Dioxythiophene), transparent conductive polymer, graphene and carbon nano tube. A patterned sensing electrode is formed by engineering processes of etching, printing, coating, lithography and photolithography, i.e. a plurality of independently disposed transparent sensing electrodes.

In the illustrated embodiment, the sensing electrode layer 130 is directly formed on a surface of the rigid transparent insulating substrate 110, and the rigid transparent insulating substrate 110 is a rigid substrate. Specifically, the rigid substrate uses strengthened glass or hardening transparent plastic plate, which is strengthened glass or reinforced plastic plate for short. The strengthened glass includes functional layers with functions of anti-glaring, hardening, antireflection or anti-fogging. The functional layer with functions of anti-glaring or anti-fogging is formed by coating paint with functions of anti-glaring or anti-fogging, the paint includes metal oxide particles; the functional layer with hardening function is formed by coating polymer paint with hardening function or by directly harden by a chemical or physical method; functional layer with antireflection function is a titania coating, a magnesium fluoride coating or a calcium fluoride coating. It is to be understood, a plastic plate with good transmittance can be manufactured to the rigid transparent substrate according to a processing method of the strengthened glass.

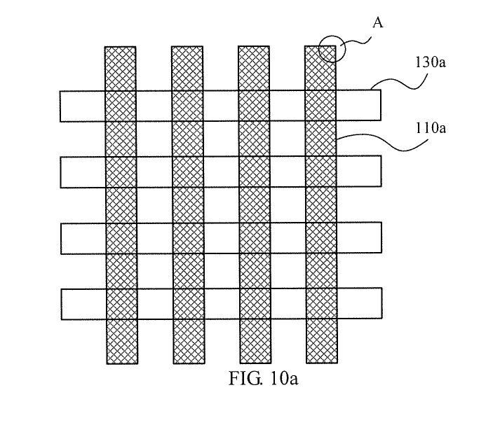

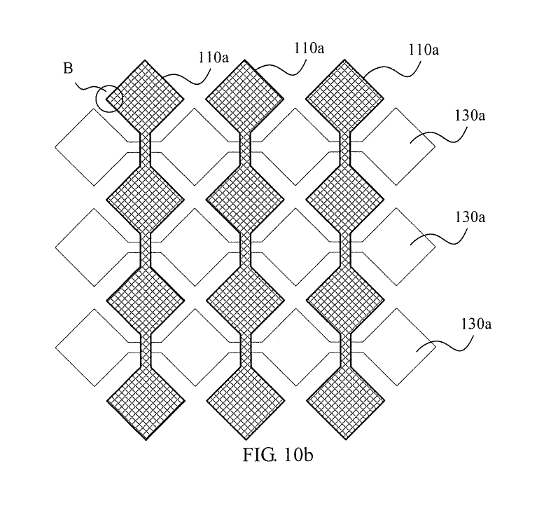

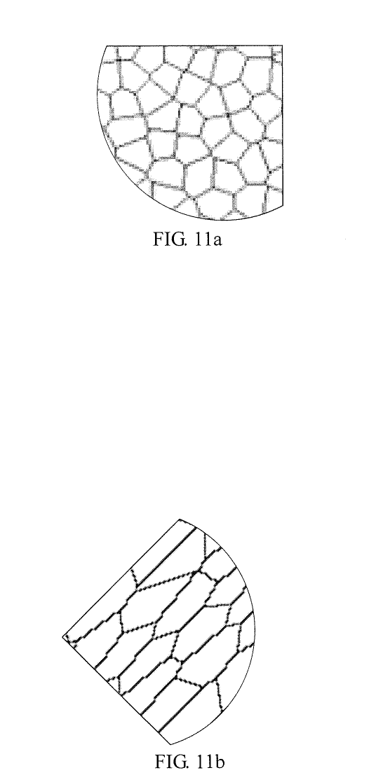

FIG. 10a and FIG. 10b are schematic plan views of arrangements and shapes of the sensing electrode and driving electrode in accordance with several types of classes of embodiments of the present disclosure. The independently disposed sensing electrodes are parallel to the first axis (X axis) and disposed equally spaced; the independently disposed driving electrodes are parallel to the second axis (Y axis) and disposed equally spaced. The sensing electrode and driving electrode of FIG. 10a are shaped as bars and arranged interlacingly and perpendicular to each other; the sensing electrode and driving electrode of FIG. 10b are shaped as diamonds and arranged interlacingly and perpendicular to each other.

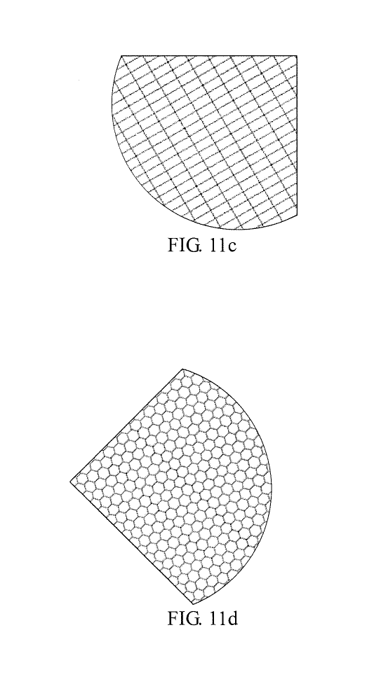

FIG. 11a, FIG. 11b, FIG. 11c and FIG. 11d are partially enlarged views correspond to part A of FIG. 10a or part B of FIG. 10b respectively in accordance with one embodiment.

The meshed conductive circuit in FIG. 11a and FIG. 11b is an irregular mesh; the manufacturing of the irregular meshed conductive circuit is simple, related processes are saved.

The meshed conductive circuit 110b of FIG. 11c and FIG. 11d is uniformly arranged regular patterns. The conductive mesh is arranged uniformly and regularly, the mesh traces spacings d1 are equal, on one hand, it makes the transmittance of the touch panel uniform; on the other hand, the surface resistance of the meshed conductive circuit is distributed uniformly, the resistance deviation is small, the settings for correcting the resistance bias are not needed to make the image uniform. The conductive mesh can be substantially orthogonal straight line lattice patterns, curved wavy line lattice patterns. The mesh cell of the meshed conductive circuit can be a regular graph, such as triangle, diamond or regular polygon etc.; it can also be an irregular graph.

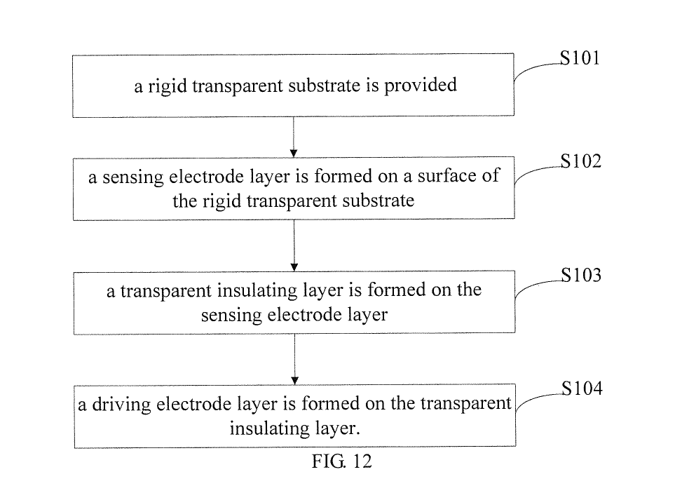

Referring to FIG. 12, it is a flowchart of the method of manufacturing a touch panel in accordance with one embodiment. Also referring to FIG. 3, the method includes the following steps.

Step S101: a rigid transparent insulating substrate is provided. The rigid transparent insulating substrate 150 is a rigid transparent insulating substrate, the rigid transparent insulating substrate can be the strengthened glass or flexible transparent panel. The flexible transparent panel is made of a material selected from a group consisting of the flexible polyethylene terephthalate (PET), polycarbonate (PC), polyethylene (PE), polyvinyl chloride (PVC), polypropylene (PP), polystyrene (PS) and polymethyl methacrylate acrylate (PMMA).

Step S102: a sensing electrode layer is formed on a surface of the rigid transparent substrate.

Step S103: a transparent insulating layer is formed on the sensing electrode layer. The transparent insulating layer is a UV adhesive. In the illustrated embodiment, in order to increase the adhesive strength between the transparent insulating layer 120 and the rigid transparent insulating substrate 150, a tackifier layer 140 is added between the rigid transparent insulating substrate 150 and the transparent insulating layer 120.

Step S104: a driving electrode layer is formed on the transparent insulating layer. A driving electrode of the driving electrode layer is a meshed conductive circuit 110b which includes a large amount of cells of the mesh (referring to FIG. 4).

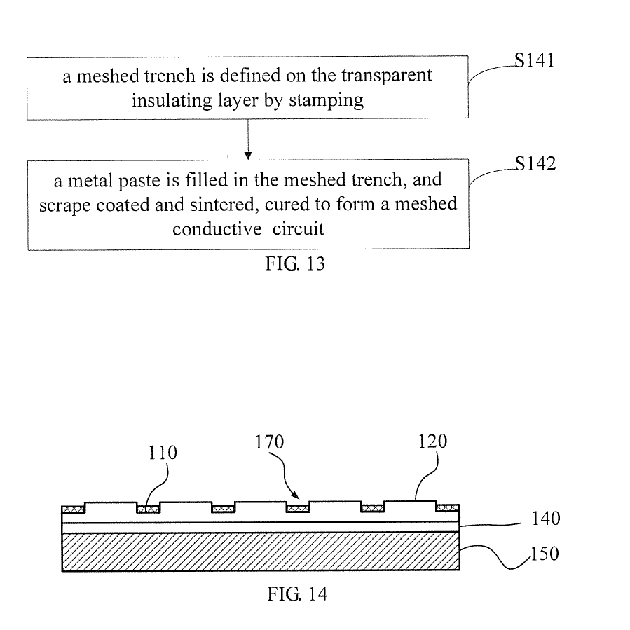

Referring to FIG. 13 and FIG. 14, step S104 includes the following steps.

Step S141: a meshed trench is defined on the transparent insulating layer by imprinting. Referring to FIG. 14, the transparent insulating layer 120 defines several meshed trenches 170 which have the same shape with the sensing electrode layer after mold pressing; the driving electrode layer 110 is formed in the meshed trench 170.

Step S142: a metal paste is filled in the meshed trench, and scrape coated and sintered, cured to form a meshed conductive circuit. The metal paste is added in the meshed trench 170, and, scrape coated to make the meshed trench fill with the metal paste, and then it is sintered, cured to form a conductive mesh. The metal paste is preferably a nano silver paste. In the other embodiment, the metal which forms the meshed conductive circuit can be one selected from a group consisting of gold, silver, copper, aluminum, zinc, gold-plated silver and alloys of at least the above two metals.

In the alternative embodiments, the meshed conductive circuit can also be manufactured by other process, for example, the meshed conductive circuit of the present disclosure is manufactured by photolithography.

The driving electrode of the touch panel is manufactured to the conductive mesh formed by the meshed conductive circuit in the above method, the touch panel do not have the problems such as the surface is easy to be scratched or peeled off, the cost is high, the surface resistance is high for the large size panel when the thin ITO film is used, so the cost of the touch panel is low, the sensitivity is high.

Although the present disclosure has been described with reference to the embodiments thereof and the best modes for carrying out the present disclosure, it is apparent to those skilled in the art that a variety of modifications and changes may be made without departing from the scope of the present disclosure, which is intended to be defined by the appended claims.

What is claimed is:

1. A touch panel, comprising:
a rigid transparent insulating substrate;
a sensing electrode layer formed on a surface of the rigid transparent insulating substrate, the sensing electrode layer comprising a plurality independently disposed sensing electrodes;
a transparent insulating layer formed on the sensing electrode layer; and
a driving electrode layer formed on the transparent insulating layer, the driving electrode layer comprising a plurality of independently disposed driving electrodes;
wherein each of the driving electrodes comprises a meshed conductive circuit; the meshed conductive circuit is embedded or buried in the transparent insulating layer.

2. The touch panel according to claim 1, wherein a mesh spacing of the meshed conductive circuit is defined as d₁, and 100 μm≦d₁<600 μm; a surface resistance of the meshed conductive circuit is defined as R, and 0.1 Ω/sq≦R<200 Ω/sq.

3. The touch panel according to claim 1, wherein the transparent insulating layer defines a plurality of interlaced meshed trenches, the meshed conductive circuit is received in the meshed trenches.

4. The touch panel according to claim 1, wherein the rigid transparent substrate is a strengthened glass.

5. The touch panel according to claim 1, wherein the sensing electrode is made of a material selected from a group consisting of transparent indium tin oxide, antimony tin oxide, indium zinc oxide, zinc aluminum, and polyethylene dioxythiophene.

6. The touch panel according to claim 1, wherein a mesh of the meshed conductive circuit is a regular geometric mesh.

7. The touch panel according to claim 1, wherein a mesh of the meshed conductive circuit is an irregular geometric mesh.

8. The touch panel according to claim 6, wherein a cell of the mesh is shaped as a single triangle, a diamond or a regular polygon.

9. The touch panel according to claim 3, further comprising a tackifier layer formed between the sensing electrode layer and the rigid transparent substrate.

10. The touch panel according to claim 9, wherein the tackifier layer is an optically transparent OCA or a LOCA.

11. The touch panel according to claim 1, wherein the meshed conductive circuit is made of silver, a mesh traces spacing of the meshed conductive circuit ranges from 200 μm to 500 μm; a surface resistance of the meshed conductive circuit is defined as R, and 4 Ω/sq≦R<50 Ω/sq, a coating amount of silver ranges from 0.7 g/m² to 1.1 g/m².

12. The touch panel according to claim 1, wherein the meshed conductive circuit is made of a material selected from a group consisting of gold, silver, copper, aluminum, zinc, gold plated silver and alloys of at least the above two metals.

13. The touch panel according to claim 1, wherein the transparent insulating layer can be formed by curing a light curing glue, thermosetting adhesive or air-drying adhesive.

14. A method of manufacturing a touch panel, comprising the following steps:
providing a rigid transparent substrate;
forming a sensing electrode layer on a surface of the rigid transparent substrate;
forming a transparent insulating layer on the sensing electrode layer; and
forming a driving electrode layer on the transparent insulating layer; a driving electrode of the driving electrode layer is a meshed conductive circuit which comprises a large amount of mesh cells.

15. The method according to claim 14, wherein the formation of the transparent insulating layer on the sensing electrode layer specifically comprises:
defining a meshed trench on the transparent insulating layer by imprinting;
forming the meshed conductive circuit in the meshed trench.

16. The method according to claim 15, wherein the formation of the meshed conductive circuit in the meshed trench specifically comprises: filling a metal paste in the meshed trench, and scrape coating, sintering and curing the metal paste.

17. The method according to claim 16, wherein the metal paste is a nano silver paste.
